(19) United States
(12) Patent Application Publication
(10) Pub. No.: US 2007/0092544 A1
(43) Pub. Date: Apr. 26, 2007

(54) Natural insect repellant

(76) Inventor: Matthew A. Mills, Woodland Hills, CA (US)

Correspondence Address: CISLO & THOMAS, LLP, 233 WILSHIRE BLVD, SUITE 900, SANTA MONICA, CA, 90401-1211, US

(21) Appl. No.: 11/209,529

(22) Filed: Aug. 23, 2005

(51) Int. Cl. A01N 65/00; A01N 25/00

(52) U.S. Cl. 424/405; 424/739; 424/770; 424/736

(57) ABSTRACT

Disclosed is a pesticide method and composition utilizing a mixture of cedar and cinnamon oils as active pesticide agents in an inert carrier. The composition may also utilize a surfactant. Exemplary embodiments disclosed herein may include up to 8.5% by volume of cedar oil, up to 8.5% cinnamon oil, lemon juice, water, and other ingredients, as desired. Exemplary embodiments may be utilized to repel insects, rodents and other things from humans and animals as well as surfaces and areas that people and pets may be near. The exemplary embodiments may provide this repellant without the harmful effects of other chemicals and repellants.

### BACKGROUND

Some insect repellants use chemicals that may be harmful to humans and animals. These chemicals may have harmful effects upon humans, animals, and other. What is needed is repellant that utilizes natural ingredients such that it may be used on humans and animals without harmful effects. Though various essential oils are known for their pesticidal properties, efforts at increasing the effectiveness of any one essential oil generally entails mixing that oil with another active agent, which is not an essential oil.

### SUMMARY

The present invention is for a pesticide method and composition utilizing a mixture of cedar and cinnamon oils as active pesticide agents in an inert carrier. The composition may also utilize a surfactant. Exemplary embodiments disclosed herein may include up to 8.5% by volume of cedar oil, up to 8.5% cinnamon oil, lemon juice, water, and other ingredients, as desired. Exemplary embodiments may be utilized to repel insects, rodents and other things from humans and animals as well as surfaces and areas that people and pets may be near. The exemplary embodiments may provide this repellant without the harmful effects of other chemicals and repellants.

### DETAILED DESCRIPTION

The detailed description set forth below is intended as a description of exemplary embodiments and is not intended to represent the only forms in which these embodiments may be constructed and/or utilized. The description sets forth the functions and the sequence of steps for constructing and operating the exemplary embodiments. However, it is to be understood that the same or equivalent functions and sequences may be accomplished by different embodiments that are also intended to be encompassed within the spirit and scope of this disclosure.

It has been found that a mixture of up to 8.5% of cedar oil with an amount of cinnamon oil up to 8.5% by volume, along with a limited amount of lemon juice acts very well as a insect repellant on a person, animal, or even around the house and other structures and surfaces. It will be appreciated that amounts of cedar and cinnamon oil may be varied for its intended use. Lesser amounts may be utilized for persons or animals with sensitive skin or in areas where a lesser amount is needed. Furthermore, greater amounts may be utilized for spraying around buildings and other structures as an insect and rodent repellant where a more powerful deterrent is desired.

Furthermore, up to 8.5% of cinnamon oil also may be utilized. It is appreciated that although these mixtures are shown as percentages by volume, other measurement techniques may be utilized as desired. It will be further appreciated that at higher concentrations, this compound may further repel snakes, gophers, lizards and other rodents.

It will be appreciated that the amounts and/or the ratios of the elements, up to 8.5% of cedar and cinnamon oil, may be varied for varying applications. For instance, smaller concentrations may be utilized for use on sensitive areas, such as skin. It will be appreciated that these smaller concentrations may still provide the repellant effect without the harmful effects of other repellant chemicals.

Greater concentrations may be utilized for less sensitive areas such as indoor and outdoor surfaces, among others. The use of exemplary embodiments may provide repellant of insects, bugs, rodents, etc. without harm to humans or animals in the area. This may be very advantageous as harmful effects of other repellants may be serious.

Further ingredients may include a surfactant. A preferred surfactant is a Tween®-80-type surfactant or Polysorbate-80. This may be utilized to allow the cedar oil to mix with and/or be suspended within water, making the oils water soluble, and the mixture homogeneous. This mixture may remain mixed, and not separate for weeks or longer. An amount of approximately 5% by volume of composition of Tween® 80 has been found to be effective for the embodiments mentioned below, though the specific amount may vary depending on the type of surfactant. The combination of cedar oil, cinnamon oil and lemon juice has been found to provide an insect repellant effect while not irritating the skin of a human or animal, in certain concentrations. Furthermore, it is comprised of all natural elements that may cause limited, if any, side effects deet-type chemicals, and others, and the like.

There may, be several different mixtures, used to create several different uses for the product. One exemplary embodiment may include a mixture of 2% cedar oil with 1% cinnamon oil, 97% water and a relatively limited quantity of lemon juice. This mixture may be used as a spray that can be applied to the body of a person, pet or livestock to protect and repel mosquitoes, flies, gnats, ticks and other types of pests. This mixture may be 100% safe for direct application. Other concentrations may be utilized depending upon the sensitivity of the skin of the user. The mixture may be more or less concentrated depending upon the sensitivity of the skin of the user, the desired insects, etc. to be repelled, or the location of use of the mixture, among other considerations. A surfactant may also be added to the mixture if desired; for example, up to approximately 5% Tween®-80 may be used with approximately 92% water.

Another exemplary embodiment may include a mixture of 3% cedar oil with .5% cinnamon oil, 96.5% water and a limited quantity of lemon juice. This mixture may be used for treatment of indoor surfaces, such as carpets, cupboards, floors, attics and interior perimeter, etc. This may drive out and/or kill all types of flying and crawling insects, including ants, roaches, fleas, ticks, mosquitoes, spiders, flies and more. This mixture may also repel reptiles such as snakes and lizards from the vicinity of the spray line. This embodiment may be used in areas that are frequented by house pets and humans without some of the adverse effects of other chemicals, etc. used for this purpose. Again, a surfactant may be added to the mixture if desired; for example, up to approximately 5% Tween®-80 may be used with approximately 91.5% water.

Another exemplary embodiment may include a mixture of 4% cedar oil with 1% cinnamon oil, 95% water and a limited quantity of lemon juice. This mixture may be used for the exterior surfaces and adjacent area, such as a yard, etc. for general insect and pest control, as well as reptile and rodent repellent. This may drive out and kill all types of flying and crawling insects, including hornets, ants, roaches, fleas, ticks, mosquitoes, spiders, flies and more, again without the harmful effects of other natural and created chemicals. Again, a surfactant may also be added to the mixture if desired; for example, up to approximately 5% Tween®-80 may be used with approximately 90% water.

The compositions are preferably formulated with a water carrier, but may be formulated with any other suitable carriers, which may be in various forms including creams, gels, waxes, etc. Other components which may be added to the composition include, but are not limited to sun screening agents, moisturizing agents, conditioning agents, skin protectants, antioxidants, sunscreen actives, viscosity modifying agents, film formers, emollients, solubilizing agents, preservatives, foaming or antifoaming agents, opacifying agents, stabilizing agents, pH adjustors, absorbents, anti-caking agents, slip modifiers, various solvents, denaturants, bulking agents, emulsion stabilizing agents, suspending agents, colorants, binders, conditioning agent-emollients, surfactant emulsifying agents, biological products, anti-acne actives, skin barrier repair aids, cosmetic soothing aids, skin lightening actives, antimicrobial and antifungal actives, sebum stimulators, sebum inhibitors, and humectants.

In closing, it is to be understood that the embodiments described herein are illustrative of the principles of the present disclosure. Other modifications that may be employed are within the scope of the disclosure. Thus, by way of example, but not of limitation, alternative configurations may be utilized in accordance with the teachings herein. Accordingly, the drawings and description are illustrative and not meant to be a limitation thereof.

### DEFINITIONS

Pesticide: any substance or mixture of substances intended for preventing, destroying, repelling, or mitigating any pest.
Inert ingredient: An inert ingredient is any ingredient in the product that is not intended to affect a target pest as defined by Federal law, the Federal Insecticide, Fungicide, and Rodenticide Act (FIFRA), since 1947. Such inert ingredients can be found on the following lists published by the US EPA Federal Registrar by the Office of Pesticide Programs, and appended hereto: 1) List 4A: Minimal risk inert ingredients and 2) List 4B: Other ingredients for which EPA has sufficient information to reasonably conclude that the current use pattern in pesticide products will not adversely affect public health or the environment (“Inert Ingredients Lists”); Inert ingredients also include commonly consumed foods whether listed or not listed on the Inert Ingredients Lists as follows.

Listed below is an Inert Ingredients List published by the US EPA Federal Registrar by the Office of Pesticide Programs, entitled “List 4A: Minimal risk inert ingredients.” This is incorporated herein by reference in its entirety and made a part of this description.

### U.S. Environmental Protection Agency

### Office of Pesticide Programs

### List of Inert Pesticide Ingredients

### List 4A—Minimal Risk Inert Ingredients—By CAS Number

### Updated August 2004

Inert Ingredients Ordered by CAS Number - List 4A Updated August 2004

| CAS | PREFIX NAME | |
|---|---|---|
| 50-70-4 | Sorbitol | 4A |
| 50-81-7 | L-Ascorbic acid | 4A |
| 50-99-7 | Dextrose | 4A |
| 56-81-5 | Glycerol (glycerin) 1,2,3 propanetriol | 4A |
| 57-10-3 | Hexadecanoic acid | 4A |
| 57-11-4 | Stearic acid | 4A |
| 57-13-6 | Urea | 4A |
| 57-50-1 | Sugar | 4A |
| 62-54-4 | Acetic acid, calcium salt | 4A |
| 63-42-3 | D- | 4A |
| | (+)-Lactose | |
| 68-04-2 | Citric acid, trisodium salt | 4A |
| 77-92-9 | Citric acid | 4A |
| 97-64-3 | Lactic acid, ethyl ester | 4A |
| 110-17-8 | Fumaric acid | 4A |
| 110-27-0 | Isopropyl myristate | 4A |
| 111-03-5 | 9-Octadecenenoic acid (Z)-, 2,3-dihydroxypropyl ester (9Cl) | 4A |
| 112-80-1 | Oleic acid | 4A |
| 121-33-5 | Vanillin | 4A |
| 123-95-5 | Butyl stearate | 4A |
| 124-38-9 | Carbon dioxide | 4A |
| 127-08-2 | Acetic acid, potassium salt | 4A |
| 127-09-3 | Acetic acid, sodium salt | 4A |
| 137-66-6 | Ascorbyl palmitate | 4A |
| 138-22-7 | Lactic acid, n-butyl ester | 4A |
| 142-18-7 | Dodecanoic acid, 2,3-dihydroxypropyl ester | 4A |
| 143-07-7 | Dodecanoic acid | 4A |
| 143-18-0 | 9-Octadecenoic acid (9Z)-, potassium salt | 4A |
| 143-19-1 | 9-Octadecenoic acid (9Z)-, sodium salt | 4A |
| 144-33-2 | Citric acid, disodium salt | 4A |
| 144-55-8 | Carbonic acid, monosodium salt | 4A |
| 298-14-6 | Carbonic acid, monopotassium salt | 4A |
| 471-34-1 | Calcium carbonate | 4A |
| 532-32-1 | Benzoic acid, sodium salt | 4A |
| 544-63-8 | Tetradecanoic acid | 4A |
| 546-93-0 | Carbonic acid, magnesium salt (1:1) | 4A |
| 553-70-8 | Benzoic acid, magnesium salt | 4A |
| 557-04-0 | Octadecanoic acid, magnesium salt | 4A |
| 557-05-1 | Octadecanoic acid, zinc salt | 4A |
| 582-25-2 | Benzoic acid, potassium salt | 4A |
| 589-68-4 | Tetradecanoic acid, 2,3-dihydroxypropyl ester | 4A |
| 593-29-3 | Octadecanoic acid, potassium salt | 4A |
| 764-71-6 | Potassium octoate | 4A |
| 813-94-5 | Citric acid, calcium salt (2:3) | 4A |
| 822-16-2 | Octadecanoic acid, sodium salt | 4A |
| 866-83-1 | Citric acid, monopotassium salt | 4A |
| 866-84-2 | Citric acid, tripotassium salt | 4A |
| 994-36-5 | Citric acid, sodium salt | 4A |
| 1002-89-7 | Octadecanoic acid, ammonium salt | 4A |
| 1302-78-9 | Bentonite | 4A |
| 1309-37-1 | Iron oxide (Fe2O3) | 4A |
| 1309-48-4 | Magnesium oxide | 4A |
| 1314-13-2 | Zinc oxide | 4A |
| 1317-60-8 | Hematite (Fe2O3) | 4A |
| 1317-61-9 | Iron oxide (Fe3O4) | 4A |
| 1317-65-3 | Limestone | 4A |
| 1318-00-9 | Vermiculite | 4A |
| 1318-02-1 | Zeolites (excluding erionite (CAS Reg. No. 66733-21-9)) | 4A |
| 1318-93-0 | Montmorillonite | 4A |
| 1323-83-7 | Octodecanoic acid, diester with 1,2,3-propanetriol (9Cl) | 4A |
| 1327-36-2 | Mullite | 4A |
| 1327-43-1 | Aluminum magnesium silicate | 4A |
| 1327-44-2 | Aluminum potassium silicate | 4A |
| 1332-09-8 | Pumice | 4A |
| 1332-58-7 | Kaolin | 4A |
| 1335-30-4 | Silicic acid, aluminum salt | 4A |
| 1343-88-0 | Silicic acid, magnesium salt | 4A |
| 1343-90-4 | Magnesium silicate, hydrate | 4A |
| 1344-00-9 | Silicic acid, aluminum sodium salt | 4A |
| 1344-95-2 | Silicic acid, calcium salt | 4A |
| 1345-25-1 | Iron oxide (FeO) | 4A |
| 1393-03-9 | Soapbark (Quillaja saponin) | 4A |
| 1406-18-4 | Vitamin E | 4A |
| 1592-23-0 | Octadecanoic acid, calcium salt | 4A |
| 1863-63-4 | Benzoic acid, ammonium salt | 4A |
| 1984-06-1 | Octanoic acid, sodium salt | 4A |
| 2090-05-3 | Benzoic acid, calcium salt | 4A |
| 3609-96-9 | Citric acid, dipotassium salt | 4A |
| 5323-95-5 | 9-Octadecenoic acid, 12-hydroxy-, monosodium salt, (9Z, 12R [symbol] | 4A |
| 5743-26-0 | Calcium acetate, monohydrate | 4A |
| 5949-29-1 | Citric acid, monohydrate | 4A |
| 6100-05-6 | Citric acid, tripotassium salt, monohydrate | 4A |
| 6107-56-8 | Calcium octanoate | 4A |
| 6132-04-3 | Citric acid, trisodium salt, dihydrate | 4A |
| 6858-44-2 | Citric acid, trisodium salt, pentahydrate | 4A |
| 6915-15-7 | Malic acid | 4A |
| 7440-44-0 | Carbon | 4A |
| 7447-40-7 | Potassium chloride | 4A |
| 7487-88-9 | Sulfuric acid, magnesium salt (1:1) | 4A |
| 7492-30-0 | 9-Octadecenoic acid, 12-hydroxy-, monopotassium salt, (9Z, | 4A |
| 7631-86-9 | Silicon dioxide (crystalline-free forms only) | 4A |
| 7646-93-7 | Potassium bisulfate | 4A |
| 7647-14-5 | Sodium chloride | 4A |
| 7693-13-2 | Citric acid, calcium salt (2:3) | 4A |
| 7699-41-4 | Silica, amorphous, precipitated and gel | 4A |
| 7704-34-9 | Sulfur | 4A |
| 7727-37-9 | Nitrogen | 4A |
| 7727-73-3 | Sulfuric acid, disodium salt, decahydrate | 4A |
| 7732-18-5 | Water | 4A |
| 7757-82-6 | Sulfuric acid, disodium salt | 4A |
| 7778-18-9 | Sulfuric acid, calcium salt (1:1) | 4A |
| 7778-49-6 | Citric acid, potassium salt | 4A |
| 7778-80-5 | Sulfuric acid, dipotassium salt | 4A |
| 7782-42-5 | Graphite | 4A |
| 8001-22-7 | Soybean oil | 4A |
| 8001-23-8 | Safflower oil | 4A |
| 8001-25-0 | Olive oil | 4A |
| 8001-26-1 | Linseed oil (unboiled) | 4A |
| 8001-29-4 | Cottonseed oil | 4A |
| 8001-30-7 | Corn oil | 4A |
| 8001-31-8 | Coconut oil | 4A |
| 8001-78-3 | Castor oil, hydrogenated | 4A |
| 8001-79-4 | Castor oil | 4A |
| 8002-03-7 | Peanut oil | 4A |
| 8002-24-2 | Sperm oil | 4A |
| 8002-31-1 | Cocoa | 4A |
| 8002-43-5 | Lecithins | 4A |
| 8002-48-0 | Malt extract | 4A |
| 8002-74-2 | Paraffin wax | 4A |
| 8002-75-3 | Palm oil | 4A |
| 8006-54-0 | Lanolin | 4A |
| 8006-95-9 | Wheat germ oil | 4A |
| 8007-69-0 | Almond oil | 4A |
| 8008-74-0 | Sesame seed oil | 4A |
| 8012-89-3 | Beeswax | 4A |
| 8013-17-0 | Invert sugar | 4A |
| 8015-86-9 | Carnauba wax | 4A |
| 8016-13-5 | Fish oil | 4A |
| 8016-70-4 | Hydrogenated soybean oil | 4A |
| 8028-66-8 | Honey | 4A |
| 8029-43-4 | Corn syrup | 4A |
| 8030-76-0 | Lecithins, soya | 4A |
| 8031-18-3 | Fuller's earth | 4A |
| 8042-47-5 | White mineral oil (petroleum) | 4A |
| 8052-35-5 | Molasses | 4A |
| 9000-07-1 | Carrageenan | 4A |
| 9000-11-7 | Cellulose, carboxymethyl ether | 4A |
| 9000-30-0 | Guar gum | 4A |
| 9000-40-2 | Carob gum (locust bean gum) | 4A |
| 9002-88-4 | Polyethylene | 4A |
| 9004-32-4 | Cellulose carboxy methyl ether, sodium salt | 4A |
| 9004-34-6 | Cellulose | 4A |
| 9004-35-7 | Cellulose acetate | 4A |
| 9004-53-9 | Dextrins | 4A |
| 9004-62-0 | Cellulose, 2-hydroxyethyl ether | 4A |
| 9004-64-2 | Cellulose, 2-hydroxypropyl ether | 4A |
| 9004-65-3 | Cellulose, 2-hydroxypropyl methyl ester | 4A |
| 9004-67-5 | Cellulose, methyl ether | 4A |
| 9005-25-8 | Cornstarch | 4A |
| 9005-38-3 | Sodium alginate | 4A |
| 9006-04-6 | Rubber | 4A |
| 9007-48-1 | 1,2,3-Propanetriol, homopolymer (9Z)-9-octadecenoate | 4A |
| 9009-32-9 | 1,2,3-Propanetriol, homopolymer, octadecanoate | 4A |
| 9050-36-6 | Maltodextrin | 4A |
| 10034-76-1 | Calcium sulfate, hemihydrate | 4A |
| 10034-99-8 | Magnesium sulfate heptahydrate | 4A |
| 10101-41-4 | Calcium sulfate, dihydrate | 4A |
| 10279-57-9 | Silica, hydrate | 4A |
| 11099-07-3 | Octodecanoic acid, ester with 1,2,3-propanetriol (9Cl) | 4A |
| 11138-66-2 | Xanthan gum | 4A |
| 12001-26-2 | Mica group minerals | 4A |
| 12001-27-3 | Lime (chemical) dolomitic | 4A |
| 12003-38-2 | Mica | 4A |
| 12003-51-9 | Silicic acid (H4SiO4), aluminum sodium salt (1:1:1) | 4A |
| 12063-19-3 | Zinc iron oxide | 4A |
| 12068-86-9 | Iron magnesium oxide (Fe2MgO4) | 4A |
| 12168-85-3 | Calcium oxide silicate (Ca3O(SiO4)) | 4A |
| 12207-97-5 | Magnesium oxide silicate (Mg3O(Si2O5)2), monohydrate | 4A |
| 12259-21-1 | Iron oxide (Fe2O3), hydrate | 4A |
| 12694-22-3 | 9-Octadecanoic acid, monoester with oxybis (propanediol) | 4A |
| 12736-96-8 | Silicic acid, aluminum potassium sodium salt | 4A |
| 13397-24-5 | Gypsum | 4A |
| 13397-26-7 | Carbonic acid, calcium salt (calcite) | 4A |
| 13429-27-1 | Tetradecanoic acid, potassium salt | 4A |
| 13776-74-4 | Silicic acid (H2SiO3), magnesium salt (1:1) | 4A |
| 13983-17-0 | Wollastonite (Ca(SiO3)) | 4A |
| 14987-04-3 | Magnesium silicon oxide (Mg2Si3O8) | 4A |
| 16389-88-1 | Dolomite (CaMg(CO3)2) | 4A |
| 18996-35-5 | Citric acid, monosodium salt | 4A |
| 24634-61-5 | Potassium sorbate | 4A |
| 25496-72-4 | 9-Octadecanoic acid (9Z)-, monoester with 1,2,3 propanetriol | 4A |
| 25637-84-7 | 9-Octodecenoic acid (9Z)-, diester with 1,2,3-propanetriol (9C | 4A |
| 26402-22-2 | Decanoic acid, monoester with 1,2,3-propanetriol | 4A |
| 26402-26-6 | Octanoic acid, monoester with 1,2,3-propanetriol | 4A |
| 26499-65-0 | Plaster of Paris | 4A |
| 26657-95-4 | Hexadecanoic acid, diester with 1,2,3-propanetriol (9Cl) | 4A |
| 26657-96-5 | Hexadecanoic acid, monoester with 1,2,3-propanetriol | 4A |
| 27214-38-6 | Tetradecanoic acid, monoester with 1,2,3-propanetriol (9Cl | 4A |
| 27215-38-9 | Dodecanoic acid, monoester with 1,2,3-propanetriol (9Cl) | 4A |
| 27638-00-2 | Dodecanoic acid, diester with 1,2,3-propanetriol (9Cl) | 4A |
| 31566-31-1 | Octodecanoic acid, monoester with 1,2,3-propanetriol | 4A |
| | (9Cl) | |
| 36354-80-0 | Octanoic acid, diester iwht 1,2,3-propanetriol | 4A |
| | (9Cl) | |
| 37244-96-5 | Nepheline syenite | 4A |
| 49553-76-6 | 9-Octadecenoic acid, ester with 1,2,3-propanetriol | 4A |
| 51395-75-6 | Cellulose, mixture with cellulose carboxymethyl ether, | 4A |
| | sodium salt | |
| 53563-63-6 | Tetradecanoic acid, diester with 1,2,3-propanetriol (9C1) | 4A |
| 53988-07-1 | Decanoic acid, diester with 1,2,3-propanetriol (9C1) | 4A |
| 60676-86-0 | Silica, vitreous | 4A |
| 61789-97-7 | Tallow | 4A |
| 61789-98-8 | Cork | 4A |
| 61789-99-9 | Lard | 4A |
| 61790-53-2 | Diatomaceous earth (less than 1% crystalline silica) | 4A |
| 63231-67-4 | Silica Gel | 4A |
| 64044-51-5 | Lactose, monohydrate | 4A |
| 65996-61-4 | Cellulose, pulp | 4A |
| 68131-04-4 | Humic acid, sodium salt | 4A |
| 68131-12-4 | Meat meal | 4A |
| 68131-37-3 | Corn syrup solids | 4A |
| 68334-00-9 | Hydrogenated cottonseed oil | 4A |
| 68409-75-6 | Bone meal | 4A |
| 68424-10-2 | Cottonseed meal | 4A |
| 68442-85-3 | Cellulose, regenerated | 4A |
| 68476-25-5 | Feldspar group minerals | 4A |
| 68476-37-9 | Glue (as depolymerized animal collagen) | 4A |
| 68476-78-8 | Cane syrup | 4A |
| 68514-28-3 | Humic acid, potassium salt | 4A |
| 68514-74-9 | Hydrogenated palm oils | 4A |
| 68514-76-1 | Citrus pulp, orange | 4A |
| 68525-86-0 | Corn flour | 4A |
| 68553-81-1 | Rice bran oil | 4A |
| 68876-77-7 | Yeast | 4A |
| 68916-18-7 | Coffee grounds | 4A |
| 68916-91-6 | Licorice extract | 4A |
| 68917-73-7 | Oils, wheat | 4A |
| 68917-75-9 | Wintergreen oil | 4A |
| 68937-99-5 | Sunflower seeds | 4A |
| 68989-22-0 | Zeolites, NaA | 4A |
| 68991-42-4 | Paprika | 4A |
| 71010-52-1 | Gellan gum (tolerance pending approval) | 4A |
| 71012-10-7 | 9-Octadecenoic acid, monoester with tetraglycerol | 4A |
| 84681-71-0 | Hydrogenated rapeseed oil | 4A |
| 85409-30-5 | Bentonite, sodian | 4A |
| 93763-70-3 | Perlite, expanded | 4A |
| 112926-00-8 | Silica gel, precipitated, crystalline-free | 4A |
| 112945-52-5 | Silica, amorphous, fumed (crystalline free) | 4A |
| 120962-03-0 | Canola oil | 4A |
| 130885-09-5 | Perlite | 4A |
| 134134-87-5 | Oat protein | 4A |
| | Animal feed items conforming to 40 CFR 180.950(b) | 4A |
| | Animal glue | 4A |
| | Cardboard | 4A |
| | Cat food | 4A |
| | Clam shells | 4A |
| | Commonly consumed food commodities conforming to 40 | 4A |
| | CFR 180.950(a) | |
| | Cotton | 4A |
| | Douglas fir bark | 4A |
| | Edible fats and oils conforming to 40 CFR 180.950(c) | 4A |
| | Egg shells | 4A |
| | Oyster shells | 4A |
| | Paper | 4A |
| | Peat moss | 4A |
| | Sawdust | 4A |
| | Vinegar (maximum of 8% acetic acid in solution) | 4A |

Listed below is an Inert Ingredients List published by the US EPA Federal Registrar by the Office of Pesticide Programs, entitled “List 4B: Other ingredients for which EPA has sufficient information to reasonably conclude that the current use pattern in pesticide products will not adversely affect public health or the environment.” This is incorporated herein by reference in its entirety and made a part of this description.

### U.S. Environmental Protection Agency

### Office of Pesticide Programs

### List of Inert Pesticide Ingredients

List 4B—Other ingredients for which EPA has sufficient information to reasonably conclude that the current use pattern in pesticide products will not adversely affect public health or the environment.—By Chemical Name Updated August 2004

Inert Ingredients Ordered Alphabetically by Chemical Name - List 4B Updated
August 2004

| CAS | PREFIX NAME | |
|---|---|---|
| 64-19-7 | Acetic acid | 4B |
| 26337-35-9 | Acetic acid ethenyl ester, polymer with carbon monoxide | 4B |
| | and ethene | |
| 137091-12-4 | Acetic acid ethenyl ester, polymer with ethanol and alpha- | 4B |
| | 2-propenyl-omega-hydroxypoly(oxy-1,2-ethandiyl) | |
| 99607-70-2 | Acetic acid, [(5-chloro-8-quinolinyl)oxy]-, 1-methylhexyl | 4B |
| | ester (9Cl) | |
| 631-61-8 | Acetic acid, ammonium salt | 4B |
| 108419-34-7 | Acetic acid, C9-11-branched alkyl esters, C10-rich | 4B |
| 108-24-7 | Acetic anhydride | 4B |
| 98-86-2 | Acetophenone | 4B |
| 77-90-7 | Acetyl tributyl citrate | 4B |
| 91994-94-4 | Acetylated lanolin alcohol | 4B |
| 9003-06-9 | Acrylamide - acrylic acid resin | 4B |
| 130353-60-5 | Acrylic acid - divinyl benzene copolymer | 4B |
| 25987-66-0 | Acrylic acid butyl ester, polymer with methacrylic acid, | 4B |
| | methyl methacrylate and styrene | |
| 24968-79-4 | Acrylic acid methyl ester, polymer with acrylonitrile | 4B |
| 27012-62-0 | Acrylic acid methyl ester, polymer with acrylonitrile and | 4B |
| | 1,3-butadiene | |
| 9003-01-4 | Acrylic acid polymer | 4B |
| 9003-04-7 | Acrylic acid polymer, sodium salt | 4B |
| 151006-66-5 | Acrylic acid terpolymer, partial sodium salt | 4B |
| 25750-84-9 | Acrylic acid, butyl ester, polymer with ethylene | 4B |
| 25119-83-9 | Acrylic acid, copolymer with butyl acrylate | 4B |
| 25987-30-8 | Acrylic acid, polymer with acrylamide, sodium salt | 4B |
| 26604-01-3 | Acrylic acid, polymer with acrylonitrile,ethyl acrylate and N- | 4B |
| | (hydroxymethyl)acrylamide | |
| 25135-39-1 | Acrylic acid, polymer with ethyl acrylate and | 4B |
| | methylmethacrylate | |
| 89678-90-0 | Acrylic acid, styrene, .alpha.-methyl styrene copolymer, | 4B |
| | ammonium salt | |
| 52831-04-6 | Acrylic acid-alpha-methylstyrene-styrene copolymer | 4B |
| 97953-25-8 | Acrylic acid-sodium acrylate-sodium-2- | 4B |
| | methylpropanesulfonate copolymer | |
| 27756-15-6 | Acrylic acid-stearyl methacrylate copolymer | 4B |
| 9003-18-3 | Acrylonitrile--butadiene copolymer | 4B |
| 137-08-6 | Alanine,N-(2,4-dihydroxy-3,3-dimethyl-1-oxobutyl)-, | 4B |
| | beta-calcium salt (2:1), (R)-(9Cl) (CA IN | |
| 68131-40-8 | Alcohols, C11-15-secondary, ethoxylated | 4B |
| 68551-13-3 | Alcohols, C12-15, ethoxylated propoxylated | 4B |
| 70632-06-3 | Alcohols, C12-15, ethoxylated, carboxylated, sodium salts | 4B |
| 69227-21-0 | Alcohols, C12-18, ethoxylated propoxylated | 4B |
| 68526-94-3 | Alcohols, C12-20, ethoxylated | 4B |
| 68920-66-1 | Alcohols, C16-18 and C18-unsatd., ethoxylated | 4B |
| 68891-29-2 | Alcohols, C8-10, ethoxylated, monoether with sulfuric | |
| | acid, ammonium salt | 4B |
| 68920-69-4 | Alcohols, C9-11, propoxylated | 4B |
| 154518-36-2 | Alcohols, C9-11-iso-, C10-rich, ethoxylated propoxylated | 4B |
| 97043-91-9 | Alcohols, C9-16, ethoxylated | 4B |
| 68527-08-2 | Alkenes, C>10 .alpha.-, polymd. | 4B |
| 142-03-0 | Aluminum acetate, basic | 4B |
| 7446-70-0 | Aluminum chloride | 4B |
| 21645-51-2 | Aluminum hydroxide | 4B |
| 6028-57-5 | Aluminum octanoate | 4B |
| 1344-28-1 | Aluminum oxide | 4B |
| 10043-01-3 | Aluminum sulfate | 4B |
| 68425-44-5 | Amides, coco, N-(hydroxyethyl), ethoxylated | 4B |
| 61791-26-2 | Amines, tallow alkyl, ethoxylated | 4B |
| 7784-25-0 | Ammonium alum | 4B |
| 7803-63-6 | Ammonium bisulfate | 4B |
| 12124-97-9 | Ammonium bromide | 4B |
| 12125-02-9 | Ammonium chloride | 4B |
| 3012-65-5 | Ammonium citrate, dibasic | 4B |
| 1336-21-6 | Ammonium hydroxide | 4B |
| 6484-52-2 | Ammonium nitrate | 4B |
| 7722-76-1 | Ammonium phosphate (monobasic) | 4B |
| 68333-79-9 | Ammonium polyphosphate | 4B |
| 7783-20-2 | Ammonium sulfate | 4B |
| 147-81-9 | Arabinose (8Cl, 9Cl) (CA INDEX NAME) | 4B |
| 84775-78-0 | Ascophyllum nodosum, ext | 4B |
| 374602-90-1 | Ashes (residues), sunflower seed hull | 4B |
| 12174-11-7 | Attapulgite | 4B |
| 7727-43-7 | Barium sulfate (1:1) | 4B |
| 8029-31-0 | Beer | 4B |
| 69011-22-9 | Benzene, diethenyl-, polymer with etenylbenzene and | 4B |
| | ethenylethylbenzene, sulfonated, sodium salts | |
| 68890-80-2 | Benzene, ethenyl-, polymer with 2,5-furandione, 2- | 4B |
| | butoxyethyl ester, ammonium salt | |
| 68648-89-5 | Benzene, ethenyl-, polymer with 2-methyl-1,3-butadiene, | 4B |
| | hydrogenated | |
| 65-85-0 | Benzoic acid | 4B |
| 10191-41-0 | Benzopyran-6-ol,3,4-dihydro-2,5,7,8-tetramethyl-2-(4,8,12- | 4B |
| | 2H-1-trimethyltridecyl)- | |
| 60864-33-7 | Benzyl ether of 1,1,3,3-tetramethylbutylphenoxypolyethoxy | 4B |
| | ethanol | |
| 61791-31-9 | N,N-Bis(2-hydroxyethyl)(coconut oil alkyl)amine | 4B |
| 87823-33-4 | Bis(6-isocyanatohexyl)-2H-1,3,5-oxadiazine-2,4,6- | 4B |
| | 3,5-(3H,5H)-trione, polymer with diethylenetriamine | |
| 1318-23-6 | Boehmite (Al(OH)O) | 4B |
| 9003-55-8 | Butadiene-styrene copolymer | 4B |
| 106-97-8 | n-Butane | 4B |
| 110-15-6 | Butanedioic acid | 4B |
| 106-65-0 | Butanedioic acid, dimethyl ester | 4B |
| 9018-04-6 | Butanediol, copolymer with 4,4′-diphenylmethane | 4B |
| | 1,4-diisocyanate and polytetramethylene glycol | |
| 71-36-3 | 1-Butanol | 4B |
| 689-82-7 | 2-Butenedioic acid (Z)-, monopotassium salt | 4B |
| 32649-30-2 | 2-Butenedioic acid (Z)-, polymer with ethenol, sodium salt | 4B |
| 139871-83-3 | Butenedioic acid (Z)-, polymer with ethenol and ethenyl | 4B |
| | 2-acetate, sodium salt | |
| 70549-17-6 | Butyl acrylate-2-ethylhexyl acrylate-2-hydroxyethyl | 4B |
| | acrylate-styrene copolymer | |
| 63744-68-3 | Butyl acrylate-ethyl acrylate-methacrylic acid-methyl | 4B |
| | methacrylate-styrene copolymer | |
| 65405-40-5 | Butyl acrylate-vinyl acetate-acrylic acid copolymer | 4B |
| 26160-96-3 | Butylated polyvinylpyrrolidone | 4B |
| 50769-39-6 | Butylpolyethoxyethanol esters of phosphoric acid | 4B |
| 96-48-0 | gamma-Butyrolactone | 4B |
| 1328-53-6 | C.I. Pigment Green 7 | 4B |
| 10043-52-4 | Calcium chloride | 4B |
| 1305-62-0 | Calcium hydroxide | 4B |
| 1305-78-8 | Calcium oxide | 4B |
| 10103-46-5 | Calcium phosphate | 4B |
| 4075-81-4 | Calcium propionate | 4B |
| 68187-71-3 | Calcium salts of tall-oil fatty acids | 4B |
| 15974-07-9 | Calcium zinc phosphate (CaZn2(PO4)2) | 4B |
| 8028-89-5 | Caramel | 4B |
| 10361-29-2 | Carbonic acid, ammonium salt | 4B |
| 506-87-6 | Carbonic acid, diammonium salt | 4B |
| 584-08-7 | Carbonic acid, dipotassium salt | 4B |
| 497-19-8 | Carbonic acid, disodium salt | 4B |
| 598-62-9 | Carbonic acid, manganese(2+) salt (1:1) | 4B |
| 1066-33-7 | Carbonic acid, monoammonium | 4B |
| 9000-71-9 | Caseins | 4B |
| 9005-42-9 | Caseins, ammonium complexes | 4B |
| 9005-46-3 | Caseins, sodium complexes | 4B |
| 68071-54-5 | Castor oil, dehydrated, polymer with p-tert-butylbenzoic | 4B |
| | acid, glycerol and phthalic anhydride | |
| 61791-12-6 | Castor oil, ethoxylated | 4B |
| 125303-89-1 | Castor oil, hydrogenated, polymer with adipic acid, | 4B |
| | ethylenediamine and 12-hydroxyoctadecanoic acid | |
| 71820-36-5 | Castor oil, maleic anhydride, and polyethylene glycol | 4B |
| | copolymer | |
| 68187-84-8 | Castor oil, oxidized | 4B |
| 68187-76-8 | Castor oil, sulfated, sodium salt | 4B |
| 8023-84-5 | Catnip | 4B |
| 65997-15-1 | Cement, portland, chemicals | 4B |
| 36653-82-4 | Cetyl alcohol | 4B |
| 29710-31-4 | Cetyl octanoate | 4B |
| 8021-99-6 | Charcoal, bone | 4B |
| 97765-70-3 | Cheese | 4B |
| 9012-76-4 | Chitosan | 4B |
| 64754-90-1 | Chlorinated polyethylene | 4B |
| | (3.beta.) | |
| 57-88-5 | -Cholest-5-en-3-ol | 4B |
| 6748-1 | Choline chloride | 4B |
| 70131-50-9 | Clay | 4B |
| 8001-69-2 | Cod liver oil | 4B |
| 20427-59-2 | Copper (II) C2449hydroxide | 4B |
| 147-14-8 | Copper phthalocyanine blue | 4B |
| 66071-94-1 | Corn, steep liquor | 4B |
| 68917-18-0 | Cornmint oil | 4B |
| 63393-89-5 | Coumarone - indene resin | 4B |
| 14464-46-1 | Cristobalite | 4B |
| 74811-65-7 | Croscarmellose sodium | 4B |
| 527-09-3 | Crustacea (raw and processed forms) | 4B |
| 10016-20-3 | Cupric gluconate | 4B |
| 128446-33-3 | alpha-Cyclodextrin | 4B |
| 111-20-6 | 1-alpha-Cyclodextrin, 2-hydroxypropyl ethers | 4B |
| 33448-5 | Decanedioic acid | 4B |
| 112-30-1 | Decanoic acid | 4B |
| 21662-09-9 | 1-Decanol | 4B |
| 41444-55-7 | 4-Decenal, (4Z)- | 4B |
| | Decyl glucoside | 4B |
| 37764-25-3 | N,N-Diallyl-2,3-dichloroacetamide | 4B |
| 7783-28-0 | Diammonium phosphate | 4B |
| 121776-33-8 | 3-(Dichloroacetyl)-5-(2-furanyl)-2,2-dimethyloxazolidine | 4B |
| 135590-91-9 | Diethyl-1-(2,4-dichlorophenyl)-5-methyl-2-pyrazolin-3,5- | 4B |
| | dicarboxylate | |
| 115-10-6 | Dimethyl ether | 4B |
| 67762-90-7 | Dimethyl silicone polymer with silica | 4B |
| 39464-64-7 | Dinonylphenol, ethoxylated, phosphated | 4B |
| 20727-33-7 | Dioctyl* sodium sulfosuccinate (* octyl is 1-methylheptyl) | 4B |
| 188027-78-3 | Dioxolo[4,5-f]benzimidazole, 6-chloro-5-[(3,5- | 4B |
| | 5H-1,3-dimethyl-4-isoxazolyl)sulfonyl]-2,2-difluoro | |
| 7722-88-5 | Diphosphoric acid, tetrasodium salt | 4B |
| 7558-79-4 | Disodium phosphate | 4B |
| 9004-82-4 | Dodecanol, ethoxylated, monoether with sulfuric acid, | 4B |
| | sodium salt | |
| 25719-52-2 | Dodecyl 2-methylacrylate polymer | 4B |
| 2618344-8 | Dodecyl alcohol, ethoxylated, monoether with sulfuric acid | 4B |
| 151-21-3 | Dodecyl sulfate, sodium salt | 4B |
| 9006-50-2 | Dried crickets | 4B |
| | Dried mealworms | 4B |
| | Egg white | 4B |
| | Eggs (raw and processed forms) | 4B |
| 36347-52-1 | Ethanaminium, N,N,N-trimethyl-2-[(2-methyl-1- | 4B |
| | oxo-2-propenyl)oxy]-, chloride, polymer with | |
| | methyl 2-methyl-2-propenoate | |
| 64-17-5 | Ethanol | 4B |
| 9003-09-2 | Ethene, methoxy-, homopolymer | 4B |
| 91-53-2 | Ethoxyquin | 4B |
| 141-78-6 | Ethyl acetate | 4B |
| 25212-88-8 | Ethyl acrylate-methacrylic acid copolymer | 4B |
| 73637-19-1 | Ethyldiaminetetraacetic acid (EDTA) disodium copper (II) sa [symbol] | 4B |
| 73637-20-4 | Ethyldiaminetetraacetic acid (EDTA) disodium manganese | 4B |
| 73513-47-0 | Ethyldiaminetetraacetic acid (EDTA) disodium zinc salt, dih [symbol] | 4B |
| 15708-41-5 | Ethyldiaminetetraacetic acid (EDTA) iron(III) sodium salt | 4B |
| 17421-79-3 | Ethyldiaminetetraacetic acid (EDTA) monosodium salt | 4B |
| 65501-24-8 | Ethyldiaminetetraacetic acid (EDTA) tripotassium salt, dihyd [symbol] | 4B |
| 26316-40-5 | Ethylene oxide-propylene oxide copolymer | 4B |
| | ethylenediamine ether | |
| 24937-78-8 | Ethylene, polymer with vinyl acetate | 4B |
| 139-33-3 | Ethylenediaminetetraacetatic acid (EDTA), disodium salt | 4B |
| 150-38-9 | Ethylenediaminetetraacetatic acid (EDTA), trisodium salt | 4B |
| 5964-35-2 | Ethylenediaminetetraacetec acid (EDTA), tetrapotassium sa [symbol] | 4B |
| 60-00-4 | Ethylenediaminetetraacetic acid (EDTA) | 4B |
| 61916-40-3 | Ethylenediaminetetraacetic acid (EDTA) disodium copper(II | 4B |
| 14729-89-6 | Ethylenediaminetetraacetic acid (EDTA) disodium iron(II) sa [symbol] | 4B |
| 15375-84-5 | Ethylenediaminetetraacetic acid (EDTA) disodium mangane [symbol] | 4B |
| 62-33-9 | Ethylenediaminetetraacetic acid (EDTA), calcium disodium | 4B |
| 12276-01-6 | Ethylenediaminetetraacetic acid (EDTA), copper (II) salt | 4B |
| 20824-56-0 | Ethylenediaminetetraacetic acid (EDTA), diammonium salt | 4B |
| 14025-15-1 | Ethylenediaminetetraacetic acid (EDTA), disodium copper(I [symbol] | 4B |
| 6381-92-6 | Ethylenediaminetetraacetic acid (EDTA), disodium salt, dihy [symbol] | 4B |
| 14025-21-9 | Ethylenediaminetetraacetic acid (EDTA), disodium zinc salt | 4B |
| 7379-27-3 | Ethylenediaminetetraacetic acid (EDTA), potassium salt | 4B |
| 7379-28-4 | Ethylenediaminetetraacetic acid (EDTA), sodium salt | 4B |
| 64-02-8 | Ethylenediaminetetraacetic acid (EDTA), tetrasodium salt | 4B |
| 67401-50-7 | Ethylenediaminetetraacetic acid (EDTA), tetrasodium salt, t [symbol] | 4B |
| 17572-97-3 | Ethylenediaminetetraacetic acid (EDTA), tripotassium salt | 4B |
| 17099-81-9 | Ethylenediaminetetraacteic acid (EDTA), iron(III) salt | 4B |
| 67762-38-3 | Fatty acids, C16-18 & C18-unsatd., Me esters | 4B |
| 67701-08-0 | Fatty acids, C16-18 and C18-unsatd | 4B |
| 162627-18-1 | Fatty acids, C18-unsatd., trimers, reaction products with | 4B |
| | triethylenetetramine | |
| 68525-90-6 | Fatty acids, C8-18, esters with sorbitol, ethoxylated | 4B |
| 68553-02-6 | Fatty acids, coco, esters with polyethylene glycol ether | 4B |
| | with glycerol (3:1) | |
| 68154-33-6 | Fatty acids, coco, esters with sorbitan, ethoxylated- | 4B |
| 68919-53-9 | Fatty acids, soya, Me esters | 4B |
| 68424-50-0 | Fatty acids, tall-oil, C12-15-alkyl esters, sulfated, sodium | 4B |
| | salts | |
| 61790-90-7 | Fatty acids, tall-oil, hexaester with sorbitol, ethoxylated | 4B |
| 68650-09-9 | Fatty acids, tall-oil, mixed esters with glycerol and | 4B |
| | polyethylene glycol | |
| 61790-92-9 | Fatty acids, tall-oil, pentaester with sorbitol, ethoxylated | 4B |
| 67761-98-2 | Fatty acids, tall-oil, polymer with ethylene glycol, | 4B |
| | pentaerythritol, and phthalic anhydride | |
| 66070-75-5 | Fatty acids, tall-oil, polymers with bisphenol A and | 4B |
| | epichlorohydrin | |
| 68605-57-2 | Fatty acids, tall-oil, polymers with bisphenol A, | 4B |
| | epichlorohydrin, rosin and tung oil | |
| 68413-17-2 | Fatty acids, tall-oil, polymers with isophthalic acid, | 4B |
| | pentaerythritol and walnut oil | |
| 68038-31-3 | Fatty acids, tall-oil, polymers with pentaerythritol, phthalic | 4B |
| | anhydride and rosin | |
| 68648-20-4 | Fatty acids, tall-oil, sesquiesters with sorbitol, ethoxylated | 4B |
| 61790-37-2 | Fatty acids, tallow | 4B |
| 61790-38-3 | Fatty acids, tallow, hydrogenated | 4B |
| 8005-44-5 | Fatty alcohols | 4B |
| 860-22-0 | FD&C Blue No. 2 | 4B |
| 25956-17-6 | FD&C Red No. 40 | 4B |
| 7705-08-0 | Ferric chloride | 4B |
| 10028-22-5 | Ferric sulfate | 4B |
| 563-71-3 | Ferrous carbonate | 4B |
| 5905-52-2 | Ferrous lactate | 4B |
| 7720-78-7 | Ferrous sulfate | 4B |
| 7782-63-0 | Ferrous sulfate heptahydrate | 4B |
| 97675-81-5 | Fish (raw and processed forms) | 4B |
| | Fish meal | 4B |
| 59-30-3 | Folic acid | 4B |
| 57-48-7 | D-Fructose | 4B |
| 68037-40-1 | Furandione, polymer with ethylbenzene, sulfonated, | 4B |
| | 2,5-sodium salt (CA INDEX NAME) | |
| 9000-70-8 | Gelatin | 4B |
| 527-07-1 | Gluconic acid, sodium salt | 4B |
| 4468-02-4 | D-Gluconic acid, zinc complex | 4B |
| 29836-26-8 | (beta-D-Glucoopyranoside, octyl | 4B |
| 29781-80-4 | (alpha- | 4B |
| | D-Glucopyranoside, octyl | |
| 59947-99-8 | beta-D-Glucoside, decyl | 4B |
| 54549-23-4 | D-Glucoside, octyl | 4B |
| 100403- | Glycerides, animal, reaction products with sucrose | 4B |
| 38-1 | | |
| 68424-61-3 | Glycerides, C16-18 and C18-unsatd. mono- and di- | 4B |
| 68002-70-0 | Glycerides, C16-22 | 4B |
| 100403-39-2 | Glycerides, palm-oil, reaction products with sucrose | 4B |
| 61789-14-8 | Glycerides, tallow sesqui-, hydrogenated | 4B |
| 100403- | Glycerides, tallow, reaction products with sucrose | 4B |
| 40-5 | | |
| 100403- | Glycerides, vegetable-oil, reaction products with sucrose | 4B |
| 41-6 | | |
| 102-76-1 | Glyceryl triacetate | 4B |
| 139-44-6 | Glyceryl tris(12-hydroxystearate) | 4B |
| 19019-43-3 | Glycine, N-(carboxymethyl)-N-[2- | 4B |
| | [(carboxymethyl)amino]ethyl]-, trisodium salt | |
| 68411-97-2 | Glycine, N-methyl-, N-coco acyl derivs. (CA INDEX | 4B |
| | NAME) (Pending) | |
| 3624-77-9 | Glycine, N-methyl-N-(1-oxo-9-octadecenyl)-, sodium salt | 4B |
| | (9Cl) (CA INDEX NAME) (Pending) | |
| 97-78-9 | Glycine, N-methyl-N-(1-oxododecyl)- | 4B |
| 142-48-3 | Glycine, N-methyl-N-(1-oxooctadecyl)- | 4B |
| 5136-55-0 | Glycine, N-methyl-N-(1-oxooctadecyl)-, sodium salt | 4B |
| 52558-73-3 | Glycine, N-methyl-N-(1-oxotetradecyl)- | 4B |
| 30364-51-3 | Glycine, N-methyl-N-(1-oxotetradecyl)-, sodium salt | 4B |
| 26635-76-7 | Glycols, plyethylene, mono(oleylamines)-ethyl ester | 4B |
| | Ground grass seed | 4B |
| 9000-01-5 | Gum Arabic | 4B |
| 12173-47-6 | Hectorite | 4B |
| 7440-59-7 | Helium | 4B |
| 111-70-6 | 1-Heptanol | 4B |
| 68511-11-5 | Hexanedioic acid, polymer with 1,4-butanediol and 1,2- | 4B |
| | propanediol, didodecanoate | |
| 125826-44-0 | Hexanedioic acid, polymer with 2,2-dimethyl- | 4B |
| | 1,3-propanediol, 1,6-hexanediol, hydrazine, 3- | |
| | hydroxy-2-(hydroxymethyl)-2-methylpropanoic | |
| | acid and 1,1′-methylenebis[4- | |
| | isocyanatocyclohexane], compd. with N,N- | |
| | diethylethanamine | |
| 114133-44-7 | Hexanedioic acid, polymer with N-(2- | 4B |
| | aminoethyl)-1,3-propanediamine, aziridine, | |
| | (chloromethyl)oxirane, 1,2-ethanediamine, N,N″- | |
| | 1,2-ethanediylbis[1,3-propanediamine], formic | |
| | acid and .alpha.-hydro.omega.-hydroxypoly(oxy- | |
| | 1,2-ethanediyl) | |
| 111-27-3 | 1-Hexanol | 4B |
| 928-96-1 | 3-Hexen-1-ol, (Z)- | 4B |
| 25213-02-9 | 1-Hexene, polymer with ethene | 4B |
| 7647-01-0 | Hydrogen chloride | 4B |
| 2809-21-4 | 1-Hydroxyethylidene-1,1-diphosphonic acid | 4B |
| 70142-34-6 | 12-Hydroxystearic acid-polyethylene glycol copolymer | 4B |
| 120-72-9 | 1H-Indole | 4B |
| 7439-89-6 | Iron (Fe) | 4B |
| 20344-49-4 | Iron hydroxide oxide (Fe(OH)O) | 4B |
| 27458-93-1 | Isooctadecanol | 4B |
| 70425-89-7 | Isooctyl acrylate-stearyl methacrylate-acrylic acid | 4B |
| | copolymer | |
| 163520-33-0 | Isoxazolecarboxylic acid, 4,5-dihydro-5,5-diphenyl-, ethyl | 4B |
| | 3-ester | |
| 50-21-5 | Lactic acid | 4B |
| 814-80-2 | Lactic acid, calcium salt (2:1) | 4B |
| 515-98-0 | Lactic acid, monoammonium salt | 4B |
| | Leaves, apple | 4B |
| 97676-23-8 | Licorice extract (licorice and licorice derivates) | 4B |
| 8061-52-7 | Lignosulfonic acid, calcium salt | 4B |
| 8061-51-6 | Lignosulfonic acid, sodium salt | 4B |
| 5989-27-5 | d-Limonene | 4B |
| 8001-26-1 | Linseed oil (boiled) | 4B |
| 67746-08-1 | Linseed oil, polymd. | 4B |
| 66071-03-2 | Linseed oil, polymd., oxidized | 4B |
| 7786-30-3 | Magnesium chloride | 4B |
| 1309-42-8 | Magnesium hydroxide | 4B |
| 18917-93-6 | Magnesium lactate | 4B |
| 10377-60-3 | Magnesium nitrate | 4B |
| 26099-09-2 | Maleic acid homopolymer | 4B |
| 25119-68-0 | Maleic acid monobutyl ester-vinyl methyl ether copolymer | 4B |
| 25087-06-3 | Maleic acid monoethyl ester-vinyl methyl ether copolymer | 4B |
| 31307-95-6 | Maleic acid monoisopropyl ester-vinyl methyl ether | 4B |
| | copolymer | |
| 9011-16-9 | Maleic anhydride - methylvinyl ether copolymer | 4B |
| 37199-81-8 | Maleic anhydride, polymer with 2,4,4-trimethylpentene, | 4B |
| | sodium salt | |
| 25266-02-8 | Maleic anhydride-1-octadecene copolymer | 4B |
| 60092-15-1 | Maleic anhydride-methylstyrene copolymer, sodium salt | 4B |
| 7785-87-7 | Manganese sulfate | 4B |
| 1344-43-0 | Manganous oxide | 4B |
| 66402-68-4 | Metakaolin | 4B |
| 100934-04-1 | Methacrylic acid-methyl methacrylate-polyethylene glycol | 4B |
| | methyl ether methacrylate copolymer | |
| 63-68-3 | L-Methionine | 4B |
| 103-26-4 | Methyl cinnamate | 4B |
| 61788-60-1 | Methyl esters of cottonseed oil | 4B |
| 119724-54-8 | Methyl methacrylate-methacrylic acid- | 4B |
| | monomethoxypolyethylene glycol methacrylate copolymer | |
| 112-62-9 | Methyl oleate | 4B |
| 99-76-3 | Methyl p-hydroxybenzoate | 4B |
| 124-10-7 | Methyl tetradecanoate | 4B |
| 25153-40-6 | Methyl vinyl ether-maleic acid copolymer | 4B |
| 62386-95-2 | Methyl vinyl ether-maleic acid copolymer calcium sodium | 4B |
| | salt | |
| 68514-61-4 | Milk (raw and processed forms) | 4B |
| | Milk, hydrolyzed | 4B |
| 9084-06-4 | Naphthalenesulfonic acid, polymer with formaldehyde, | 4B |
| | sodium salt | |
| 58846-77-8 | N-Decyl glucoside | 4B |
| 7697-37-2 | Nitric acid | 4B |
| | Nitrogen fixing bacteria | 4B |
| 26027-38-3 | p-Nonylphenol, ethoxylated | 4B |
| 9081-17-8 | Nonylphenol, ethoxylated, monoether with sulfuric acid | 4B |
| 9014-90-8 | Nonylphenol, ethoxylated, monoether with sulfuric acid, | 4B |
| | sodium salt | |
| 57451-03-3 | Nonylphenol, ethoxylated, monoether with sulfuric acid, | 4B |
| | triethanolamine salt | |
| 51609-41-7 | 4-Nonylphenol, ethoxylated, phosphate ester | 4B |
| 51811-79-1 | Nonylphenol, ethoxylated, phosphate ester | 4B |
| 37340-60-6 | Nonylphenol, ethoxylated, phosphate ester, sodium salt | 4B |
| 58128-22-6 | Octadecanoic acid, 12-hydroxy-, homopolymer, | 4B |
| | octadecanoate | |
| 637-12-7 | Octadecanoic acid, aluminum salt | 4B |
| 143-28-2 | 9-Octadecen-1-ol, (9Z)- | 4B |
| 544-60-5 | 9-Octadecenoic acid (9Z)-, ammonium salt | 4B |
| 124-07-2 | Octanoic acid | 4B |
| 41444-50-2 | Octyl glucoside | 4B |
| 31800-88-1 | Octyloxypoly(ethyleneoxy)ethyl phosphate | 4B |
| 72869-69-3 | Oils, apricot | 4B |
| 8015-73-4 | Oils, basil | 4B |
| 8021-28-1 | Oils, Fir | 4B |
| 8000-46-2 | Oils, geranium | 4B |
| 8007-08-7 | Oils, ginger | 4B |
| 8016-20-4 | Oils, grapefruit | 4B |
| 68153-10-6 | Oils, lard, sulfated, sodium salts, | 4B |
| 8022-15-9 | Oils, lavandin | 4B |
| 128497-20-1 | Oils, Macadamia | 4B |
| 68201-51-4 | Oils, menhaden, oxidized | 4B |
| 9000-50-4 | Oils, oakmoss-resinoid (CA INDEX NAME) | 4B |
| 68514-75-0 | Oils, orange-juice | 4B |
| 132538-94-4 | Oils, orange-juice, citrus sinensis | 4B |
| 8014-19-5 | Oils, palmarosa | 4B |
| 8000-25-7 | Oils, rosemary | 4B |
| 8022-56-8 | Oils, sage | 4B |
| 8016-85-1 | Oils, tangerine | 4B |
| 8016-96-4 | Oils, vetiver | 4B |
| 8002-72-0 | Onions, oil | 4B |
| 8008-57-9 | Orange oil | 4B |
| 97766-30-8 | Orange, sweet, valencia, ext. | 4B |
| 71526-07-3 | 1-Oxa-4-azaspiro[4.5]decane, 4-(dichloroacetyl)- | 4B |
| 68441-17-8 | Oxidized polyethylene | 4B |
| 61725-89-1 | Oxirane, methyl-, polymer with oxirane, tridecyl ether | 4B |
| 39362-51-1 | Oxirane, methyl-, polymer with oxirane, acetate | 4B |
| 9038-29-3 | Oxirane, methyl-, polymer with oxirane, decyl ether | 4B |
| 68585-15-9 | Oxirane, methyl, polymer with oxirane, mono C6-C10 alkyl | 4B |
| | ethers, phosphates | |
| 85637-75-8 | Oxirane, methyl-, polymer with oxirane, mono[2-(2- | 4B |
| | butoxyethoxy) ethyl]ether | |
| 134180-76-0 | Oxirane, methyl-, polymer with oxirane, mono[3-[1,3,3,3- | 4B |
| | tetramethyl-1-[(trimethylsilyl)oxy]disiloxanyl]propyl]ether | |
| 9041-33-2 | Oxirane, methyl-, polymer with oxirane, mono-2-propenyl | 4B |
| | ether | |
| 56090-69-8 | Oxirane, methyl-, polymer with oxirane, monoacetate, 2- | 4B |
| | propenyl ether | |
| 61827-84-7 | Oxirane, methyl-, polymer with oxirane, octyl ether | 4B |
| 7782-44-7 | Oxygen | 4B |
| 68476-82-4 | Peanut meal | 4B |
| | Peanut shells | 4B |
| | Peanuts (raw and processed forms) | 4B |
| | Pecan shell flour | 4B |
| 9000-69-5 | Pectin | 4B |
| 78-23-9 | Pentaerythritol monostearate | 4B |
| 115-83-3 | Pentaerythritol tetrastearate | 4B |
| 8009-03-8 | Petrolatum | 4B |
| 7664-38-2 | Phosphoric acid | 4B |
| 7757-93-9 | Phosphoric acid, calcium salt (1:1) | 4B |
| 7758-23-8 | Phosphoric acid, calcium salt (2:1) | 4B |
| 7757-86-0 | Phosphoric acid, magnesium salt (1:1) | 4B |
| 13092-66-5 | Phosphoric acid, magnesium salt (2:1) | 4B |
| 7757-87-1 | Phosphoric acid, magnesium salt (2:3) | 4B |
| 7778-53-2 | Phosphoric acid, tripotassium salt 4B | |
| 7779-90-0 | Phosphoric acid, zinc salt (2:3) | 4B |
| 8002-09-3 | Pine oil | 4B |
| 80-56-8 | alpha-Pinene | 4B |
| 25719-60-2 | beta-Pinene homopolymer | 4B |
| 125997-17-3 | Poly(oxy-1,2-ethandiyl),.alpha.-acetyl-.omega.-[3-{1,3,3,3- | 4B |
| | tetramethyl-1-[(trimethylsilyl)oxy]disiloxanyl]propoxy)- | |
| 68908-64-5 | Poly(oxy-1,2-ethanediyl), .alpha.-hydro-.omega.-hydroxy-, | 4B |
| | mono-C10-12-alkyl ethers, phosphates | |
| 68601-19-5 | Poly(oxy-1,2-ethanediyl), .alpha.,.alpha.'-[[methyl[3- | 4B |
| | (tridecyloxy)propyl]imino]di-2,1-ethanediyl | |
| 73050-08-5 | Poly(oxy-1,2-ethanediyl), .alpha.,.alpha.'- | 4B |
| | phosphinicobis[.omega.-hydroxy-, di-C13-15-alkyl ethers, | |
| | sodium salts | |
| 67674-67-3 | Poly(oxy-1,2-ethanediyl), .alpha.-3-[1,3,3,3-tetramethyl-1- | 4B |
| | [(trimethylsilyl)oxy]disiloxanyl]propyl]-omega.-hydroxy- | |
| 143819-63-0 | Poly(oxy-1,2-ethanediyl), .alpha.-hydro-.omega.-hydroxy-, | 4B |
| | monoether with (hydroxymethyl)decane | |
| 119432-41-6 | Poly(oxy-1,2-ethanediyl), .alpha.-sulfo-.omega.-[tris(1- | 4B |
| | phenylethyl)phenoxy]-ammonium salt | |
| 59800-21-4 | Poly(oxy-1,2-ethanediyl), alpha-hydro-omega-hydroxy-, | 4B |
| | ether with D-glucitol (6:1), (z)-9-octadecenoate | |
| 68130-47-2 | Poly(oxy-1,2-ethanediyl), alpha-hydro-omega-hydroxy- | 4B |
| | mono-C8-10-alkyl ethers, phosphates | |
| 69364-63-2 | Poly(oxy-1,2-ethanediyl), alpha-isohexadecyl-omega- | 4B |
| | hydroxy- | |
| 73038-25-2 | Poly(oxy-1,2-ethanediyl), alpha-isotridecyl-omega-hydroxy-, | 4B |
| | phosphate | |
| 27252-80-8 | Poly(oxy-1,2-ethanediyl), alpha-methyl-omega- | 4B |
| | (2-propenyloxy)-(CA INDEX NAME) | |
| 27306-78-1 | Poly(oxy-1,2-ethanediyl), alpha-methyl-omega- | 4B |
| | [3-[1,3,3,3-tetramethyl-1- | |
| | [(trimethylsilyl)oxy]disiloxanyl]propoxy]-(2- | |
| | propenyloxy)- | |
| 73050-07-4 | Poly(oxy-1,2-ethanediyl),.alpha.- | 4B |
| | (butoxyhydroxyphosphinyl)-.omega.-hydroxy-,C13-15-alkyl | |
| | ethers,sodium salts | |
| 27274-31-3 | Poly(oxy-1,2-ethanediyl),.alpha.-2-propenyl-.omega.- | 4B |
| | hydroxy- | |
| 78330-24-2 | Poly(oxy-1,2-ethanediyl), .alpha.-hydro-.omega.-hydroxy-, | 4B |
| | mono-C11-14-isoalkyl ethers, C13-rich, phosphates | |
| 73050-09-6 | Poly(oxy-1,2-ethanediyl),.alpha.-phosphono-.omega.- | 4B |
| | hydroxy-,C13-15-alkyl ethers, disodium salts | |
| 127036-24-2 | Poly(oxy-1,2-ethanediyl), .alpha.-undecyl-.omega.-hydroxy-, | 4B |
| | branched and linear | |
| 25038-59-9 | Poly(oxy-1,2-ethanediyloxycarbonyl-1,4-phenylenecarbonyl | 4B |
| 56388-96-6 | Poly(oxyethylene)tridecylacetic acid | 4B |
| 102900-02-7 | Poly(oxyethylene/oxypropylene) monoalkyl(C6-C10)ether | |
| | sodium fumarate adduct | 4B |
| 63231-81-2 | Poly(vinylpyrrolidone-1-hexadecene) | 4B |
| 27937-16-4 | Poly[imino(1-oxo-1,12-dodecanediyl)] | 4B |
| 9064-13-5 | Poly[oxy(methyl-1,2-ethanediyl)],alpha-(methylphenyl)- | 4B |
| | omega-hydroxy- | |
| 74775-06-7 | Poly[oxy(methyl-1,2-ethanediyl)],.alpha.-(1-oxopropyl)- | 4B |
| | omega.-(tetradecyloxy)- | |
| 176022-82-5 | Poly[oxy(methyl-1,2-ethanediyl)],.alpha.-[2-[bis(2-, | 4B |
| | hydroxyethyl)amino]propyl]-.omega.-hydroxy-, ether | |
| | with.alpha.-hydro-.omega.-hydroxypoly(oxy-1,2- | |
| | ethanediyl) (1:2), mono-C12-16-alkyl ethers | |
| 9003-05-8 | Polyacrylamide | 4B |
| 63428-83-1 | Polyamide resins | 4B |
| 25322-68-3 | Polyethylene glycol | 4B |
| 9014-85-1 | Polyethylene glycol ether with 1,4-diisobutyl-1,4- | 4B |
| | dimethylbutynediol (2:1) | |
| 41928-09-0 | Polyethylene glycol ether with 2,2′-methylenebis(4-(tert- | 4B |
| | octyl)phenol) (2:1) | |
| 60874-89-7 | Polyethylene glycol ether with methylenebis(diamylphenol) | 4B |
| 55069-68-6 | Polyethylene glycol hexaether with sorbitol, diester with | 4B |
| | dodecanoic and oleic acids | |
| 99734-09-5 | Polyethylene glycol mono(tristyrylphenyl)ether | 4B |
| 59139-23-0 | Polyethylene glycol nonylphenyl ether phosphate | 4B |
| | ethanolamine salt | |
| 67922-57-0 | Polyethylene glycol nonylphenyl ether phosphate | 4B |
| | magnesium salt | |
| 52503-15-8 | Polyethylene glycol nonylphenyl ether phosphate | 4B |
| | potassium salt | |
| 68650-28-2 | Polyethylene glycol-polyisobutenyl anhydride-tall oil fatty | 4B |
| | acid copolymer | |
| 132175-04-3 | Polyethylene glycol-polyisobutenyl anhydride-tall oil fatty | 4B |
| | acid copolymer | |
| 9003-68-3 | Polyethylene terephthalate | 4B |
| 24938-04-3 | Polyethylene terphthalate-polyethylene isophthalate film | 4B |
| 9038-95-3 | Polyethylene-polypropylene glycol, monobutyl ether | 4B |
| 63705-03-3 | Polyglycerol diisostearate | 4B |
| 66070-87-9 | Polyglyceryl phthalate ester of coconut oil fatty acid | 4B |
| | Polymer of n-butyl acrylate, methyl methacryalate, | 4B |
| | methacrylic acid and aminopropyl methacrylate | |
| 30938-41-1 | Polymer of vinyl acetate, n-butyl acrylate, vinyl chloride, | 4B |
| | and acrylic acid | |
| 9003-49-0 | Polymerized butyl acrylate | 4B |
| 9011-14-7 | Polymethyl methacrylate | 4B |
| 9036-19-5 | Polyoxyethylene (1,1,3,3-tetramethylbutyl)phenyl ether | 4B |
| 60828-78-6 | Polyoxyethylene 2,6,8-trimethyl-4-nonyl ether | 4B |
| 9014-93-1 | Polyoxyethylene dinonylpheno | 4B |
| 9005-07-6 | Polyoxyethylene dioleate | 4B |
| 9005-08-7 | Polyoxyethylene distearate | 4B |
| 26636-40-8 | Polyoxyethylene docosyl ether | 4B |
| 9002-92-0 | Polyoxyethylene dodecyl mono ether | 4B |
| 9014-92-0 | Polyoxyethylene dodecylpheno | 4B |
| 8050-33-7 | Polyoxyethylene ester of rosin | 4B |
| 51192-09-7 | Polyoxyethylene glycerin monooleate | 4B |
| 9004-98-2 | Polyoxyethylene mono(cis-9-octadecenyl) ether | 4B |
| 26183-52-8 | Polyoxyethylene monodecyl ether | 4B |
| 26636-39-5 | Polyoxyethylene monoeicosyl ether | 4B |
| 9004-95-9 | Polyoxyethylene monohexadecyl ether | 4B |
| 9004-81-3 | Polyoxyethylene monolaurate | 4B |
| 9005-00-9 | Polyoxyethylene monooctadecyl ether | 4B |
| 9004-96-0 | Polyoxyethylene monooleate | 4B |
| 9004-99-3 | Polyoxyethylene monostearate | 4B |
| 27306-79-2 | Polyoxyethylene monotetradecyl ether | 4B |
| 9016-45-9 | Polyoxyethylene nonylpheno | 4B |
| 51617-79-9 | Polyoxyethylene octadecylpheno | 4B |
| 37280-82-3 | Polyoxyethylene polyoxypropylene phosphate | 4B |
| 9005-64-5 | Polyoxyethylene sorbitan monolaurate | 4B |
| 9005-65-6 | Polyoxyethylene sorbitan monooleate | 4B |
| 9005-66-7 | Polyoxyethylene sorbitan monopalmitate | 4B |
| 9005-67-8 | Polyoxyethylene sorbitan monostearate | 4B |
| 9005-70-3 | Polyoxyethylene sorbitan trioleate | 4B |
| 9005-71-4 | Polyoxyethylene sorbitan tristearate | 4B |
| 31307-92-3 | Polyoxyethylene sorbitol | 4B |
| 57171-56-9 | Polyoxyethylene sorbitol hexaoleate | 4B |
| 9011-29-4 | Polyoxyethylene sorbitol hexastearate | 4B |
| 61824-34-8 | Polyoxyethylene sorbitol pentaoleate | 4B |
| 63089-86-1 | Polyoxyethylene sorbitol tetraoleate | 4B |
| 163436-84-8 | Polyoxyethylene tristyrylphenol phosphate, potassium salt | 4B |
| 9003-11-6 | Polyoxyethylene-polyoxypropylene copolymer | 4B |
| 37286-64-9 | Polyoxypropylene monomethyl ether | 4B |
| 25231-21-4 | Polyoxypropylene monostearyl ether | 4B |
| 68458-49-1 | Polyphosphoric acids, esters with polyethylene glycol | 4B |
| | nonylphenyl ether | |
| 9003-07-0 | Polypropylene | 4B |
| 25322-69-4 | Polypropylene glycol | 4B |
| 31394-71-5 | Polypropylene glycol monooleate | 4B |
| 9003-53-6 | Polystyrene resin | 4B |
| 53504-41-9 | Polyurethane | 4B |
| 9003-20-7 | Polyvinyl acetate | 4B |
| 9002-89-5 | Polyvinyl alcohol | 4B |
| 9002-86-2 | Polyvinyl chloride resin | 4B |
| 9003-39-8 | Polyvinylpyrrolidone | 4B |
| 25086-89-9 | Polyvinylpyrrolidone-vinyl acetate copolymer | 4B |
| 61789-30-8 | Potassium coconut oil soap | 4B |
| 1310-58-3 | Potassium hydroxide | 4B |
| 14977-37-8 | Potassium magnesium sulfate (Mg2K2(SO4)3) | 4B |
| 7758-11-4 | Potassium phosphate (dibasic) | 4B |
| 7778-77-0 | Potassium phosphate, monobasic | 4B |
| 69669-25-6 | Potassium salts of fatty acids (C12-C20) | 4B |
| 67701-09-1 | Potassium salts of fatty acids (C8-18 and C18 unsatd.) | 4B |
| 59766-31-3 | Potassium titanium oxide (K2Ti8O17) | 4B |
| 78266-09-8 | Propanesulfonic acid, 2-hydroxy-3-(2-propenyloxy)- | 4B |
| | 1-,monosodium salt, polymer with 2-propenoic acid | |
| 17217-76-4 | Propanetricarboxylic acid, 2-hydroxy-, iron (3+) salt (1:1), | 4B |
| | 1,2,3-trihydrate | |
| 74504-64-6 | 1,2,3-Propanetriol, homopolymer, dodecanoate | 4B |
| 79-09-4 | Propanoic acid | 4B |
| 67-63-0 | 2-Propanol | 4B |
| 71-23-8 | 1-Propanol | 4B |
| 109961-42-4 | Propenenitrile, polymer with 1,2,4-triethenylcyclohexane, | 4B |
| | 2-hydrolyzed | |
| 9003-18-3 | 2-Propenenitrile, polymer with 1,3-butadiene | 4B |
| 9003-56-9 | Propenenitrile, polymer with 1,3-butadiene and | 4B |
| | 2-ethenylbenzene | |
| 24938-16-7 | Propenoic acid, 2-methyl-, butyl ester, polymer with 2- | |
| | (dimethylamino)ethyl 2-methyl-2-propenoate and methyl 2- | |
| | 2-methyl-2-propenoate | |
| 63150-03-8 | Propenoic acid, 2-methyl-, dodecyl ester, polymer with | 4B |
| | eicosyl 2-methyl-2-propenoate, hexadecyl 2-methyl-2- | |
| | propenoate, octadecyl 2-methyl-2-propenoate, pentadecyl | |
| | 2-methyl-2-propenoate, tetradecyl 2-methyl-2-propenoate | |
| | 2-and tridecyl 2-methyl-2-propenoate | |
| 71394-17-7 | Propenoic acid, 2-methyl-, polymer with butyl 2-methyl-2- | 4B |
| | propenoate, ethenylbenzene, 2-ethylhexyl 2-propenoate | |
| | 2-and methyl 2--methyl-2-propenoate | |
| 26873-77-8 | Propenoic acid, 2-methyl-, polymer with ethenylbenzene, | 4B |
| | 2-2-ethylhexyl 2-propenoate and 2-propene | |
| 55989-05-4 | Propenoic acid, 2-methyl-, polymer with ethyl 2- | 4B |
| | propenoate and methyl 2-methyl-2-propenoate, | |
| | 2-ammonium salt | |
| 41487-53-0 | Propenoic acid, 2-methyl-, polymer with ethyl 2- | 4B |
| | 2-propenoate, sodium salt | |
| 89511-79-5 | Propenoic acid, 2-methyl-,polymer with ethyl 2-propenoate | 4B |
| | 2-and methyl 2-methyl-2-propenoate, sodium salt | |
| 30795-23-4 | Propenoic acid, butyl ester, polymer with ethenylbenzene | 4B |
| | 2-and 2-ethylhexyl 2-propenoate | |
| 29437-34-1 | Propenoic acid, butyl ester, polymer with ethyl 2- | 4B |
| | 2-propenoate and 2-propenenitrile | |
| 25608-12-2 | 2-Propenonic acid, homopolymer, potassium salt | 4B |
| 25085-39-6 | Propenoic acid, polymer with, 1,3-butadiene and | 4B |
| | 2-ethenylbenzene | |
| 86864-96-2 | Propenoic acid, polymer with 2-hydroxypropyl 2- | 4B |
| | 2-propenoate and sodium 2-propenoate | |
| 114033-68-0 | Propenoic acid, polymer with 2-propanol, reaction | 4B |
| | 2-products with sodium acrylate | |
| 9033-79-8 | 2-Propenoic acid, polymer with sodium 2-propenoate | 4B |
| 94-13-3 | Propyl p-hydroxybenzoate | 4B |
| 57-55-6 | Propylene glycol | 4B |
| 9005-37-2 | Propylene glycol alginate | 4B |
| 58-08-2 | 1H-Purine-2,6-dione, 3,7-dihydro-1,3,7-trimethyl- | 4B |
| 12269-78-2 | Pyrophyllite | 4B |
| 28211-18-9 | 2-Pyrrolidinone, 1-ethenyl-, polymer with 1-eicosene | 4B |
| 73891-99-3 | Rape oil, Me ester | 4B |
| 8023-77-6 | Resins, oleo-, capsicum | 4B |
| 81-88-9 | Rhodamine 8 (conforming to 40 CFR 180.2020) | 4B |
| 68152-57-8 | Rosin, fumarated, polymer with ethylene glycol and | 4B |
| | pentaerythritol (CA INDEX NAME) | |
| 68333-69-7 | Rosin, maleated, polymer with pentaerythritol | 4B |
| | Sand | 4B |
| | Seeds, lettuce | 4B |
| 68909-20-6 | Silanamine, 1,1,1-trimethyl-N-(trimethylsilyl)-, hydrolysis | 4B |
| | products with silica | |
| 68611-44-9 | Silane, dichlorodimethyl-, reaction products with silica | 4B |
| 1343-98-2 | Silicic acid | 4B |
| 13870-28-5 | Silicic acid (H2Si2O5), disodium salt | 4B |
| 6834-92-0 | Silicic acid (H2SiO3), disodium salt | 4B |
| 15593-82-5 | Silicic acid (H6Si2O7), hexasodium salt | 4B |
| 10213-79-3 | Silicic acid, disodium salt, pentahydrate | 4B |
| 1312-76-1 | Silicic acid, potassium salt | 4B |
| 1344-09-8 | Silicic acid, sodium salt | 4B |
| 63148-62-9 | Silicones and siloxanes, dimethyl | 4B |
| | Silkworm pupae | 4B |
| 117272-76-1 | Siloxanes and silicones, 3-hydroxypropyl Me, ethers with | 4B |
| | polyethylene glycol mono-Me ether | |
| 68554-64-3 | Siloxanes and silicones, di-Me, 3-hydroxypropyl Me, | 4B |
| | ethers with polyethylene glycol mono-Me ether | |
| 68938-54-5 | Siloxanes and silicones, di-Me, 3-hydroxypropyl Me, | 4B |
| | ethers with polyethylene glycol mono-Me ether | |
| 67762-87-2 | Siloxanes and silicones, di-Me, 3-hydroxypropyl Me, | 4B |
| | ethers with polyethylene-polypropylene glycol | |
| 68440-66-4 | Siloxanes and silicones, di-Me, 3-hydroxypropyl Me, | 4B |
| | ethers with polypropylene glycol mono-Bu ethe | |
| 68937-55-3 | Siloxanes and silicones, di-Me, 3-hydroxypropyl Me, | 4B |
| | ethoxylated propoxylated | |
| 68037-62-7 | Siloxanes and silicones, di-Me, Me hydrogen, reaction | 4B |
| | products with polyethylene glycol monoacetate | |
| 67762-96-3 | Siloxanes and silicones, di-Me, hydroxy-terminated, ethers | 4B |
| | with polypropylene glycol mono-Bu ether | |
| 67701-10-4 | Soap: (Fatty acids, C8-18 and C18-unsatd., sodium salts) | 4B |
| 7758-16-9 | Sodium acid pyrophosphate | 4B |
| 25085-02-3 | Sodium acrylate, polymer with acrylamide | 4B |
| 1302-42-7 | Sodium aluminate | 4B |
| 7785-88-8 | Sodium aluminum phosphate | 4B |
| 134-03-2 | Sodium ascorbate | 4B |
| 577-11-7 | Sodium bis(2-ethylhexyl) sulfosuccinate | 4B |
| 7681-38-1 | Sodium bisulfate | 4B |
| 7647-15-6 | Sodium bromide | 4B |
| 126-96-5 | Sodium diacetate | 4B |
| 7558-80-7 | Sodium dihydrogen phosphate | 4B |
| 1639-66-3 | Sodium dioctyl sulfosuccinate | 4B |
| 7681-49-4 | Sodium fluoride | 4B |
| 10124-56-8 | Sodium hexametaphosphate | 4B |
| 1310-73-2 | Sodium hydroxide | 4B |
| 7681-53-0 | Sodium hypophosphite | 4B |
| 7631-99-4 | Sodium nitrate | 4B |
| 7632-05-5 | Sodium phosphate | 4B |
| 137-40-6 | Sodium propionate | 4B |
| 533-96-0 | Sodium sesquicarbonate | 4B |
| 8052-48-0 | Sodium tallow soap | 4B |
| 868-18-8 | Sodium tartrate | 4B |
| 7772-98-7 | Sodium thiosulfate | 4B |
| 10102-17-7 | Sodium thiosulfate, pentahydrate | 4B |
| 54116-08-4 | Sodium tridecylpoly(oxyethylene) sulfate | 4B |
| 7758-29-4 | Sodium tripolyphosphate | 4B |
| 110-44-1 | Sorbic acid | 4B |
| 26266-57-9 | Sorbitan monohexadecanoate | 4B |
| 1338-41-6 | Sorbitan monostearate | 4B |
| 68646-20-4 | Sorbitol tall oil fatty acid sesquiester, ethoxylated | 4B |
| 68513-95-1 | Soy flour | 4B |
| 68308-36-1 | Soybean meal | 4B |
| 61791-23-9 | Soybean oil, ethoxylated | 4B |
| 67762-09-8 | Soybean oil, polymer with ethylene glycol, glycerol, | 4B |
| | pentaerythritol and phthalic anhydride | |
| 68309-49-9 | Soybean oil, polymer with isophthalic acid, linseed oil and | 4B |
| | trimethylolpropane | |
| 66071-16-7 | Soybean oil, polymer with maleic anhydride | 4B |
| 68131-29-3 | Soybean oil, polymer with phthalic anhydride, trimellitic | 4B |
| | anhydride and trimethylolpropane | |
| | Soybeans (raw and processed forms) | 4B |
| 8008-79-5 | Spearmint oil | 4B |
| 63798-35-6 | Starch acetate adipate | 4B |
| 65996-63-6 | Starch, acid-hydrolyzed | 4B |
| 9063-38-1 | Starch, carboxymethyl ether, sodium salt | 4B |
| 9011-13-6 | Styrene-maleic anhydride resin | 4B |
| 25085-34-1 | Styrene acrylic acid copolymer | 4B |
| 68630-83-1 | Styrene, polymer with methacrylic acid and | 4B |
| | polyethoxylated (Z)-2-butenedioic acid | |
| 9003-70-7 | Styrene-divinyl benzene copolymer resin matrix | 4B |
| 25750-06-5 | Styrene-methyl methacrylate-2-ethylhexyl acrylate | 4B |
| | copolymer | |
| 8002-33-3 | Sulfated castor oil | 4B |
| 10025-67-9 | Sulfur chloride | 4B |
| | Sulfur Coated Urea | 4B |
| 7664-93-9 | Sulfuric acid | 4B |
| 68919-54-0 | Sunflower-oil fatty acids, Me ester | 4B |
| 8028-48-6 | Sweet orange peel tincture | 4B |
| 14807-96-6 | Talc | 4B |
| 8030-12-4 | Tallow, hydrogenated | 4B |
| 104133-09-7 | Tetraethoxysilane, polymer with hexamethyldisiloxane | 4B |
| 811-97-2 | 1,1,1,2-Tetrafluoroethane | 4B |
| 7320-34-5 | Tetrapotassium pyrophosphate | 4B |
| 58-56-0 | Thiamine mononitrate | 4B |
| | Thumb tacks | 4B |
| 13463-67-7 | Titanium dioxide | 4B |
| | Tree nuts (raw and processed forms) | 4B |
| 68002-20-0 | Triazine-2,4,6-triamine, polymer with formaldehyde, | 4B |
| | 1,3,5-methylated | |
| 7758-87-4 | Tricalcium phosphate | 4B |
| 26915-70-8 | Tridecanol, ethoxylated, phospate ester | 4B |
| 15468-32-3 | Tridymite (SiO2) | 4B |
| 105362-40-1 | Triethanolamine, compd. with poly(oxyethylene) | 4B |
| | tristyrylphenyl ether phosphate | |
| 1317-95-9 | Tripoli | 4B |
| 132580-45-1 | Alpha-Tris[1-(phenyl)ethyl}phenyl]-omega- | 4B |
| | [2,4,6-hydroxypoly(oxyethylene)poly(oxypropylene) copolymer | |
| 7601-54-9 | Trisodium phosphate | 4B |
| 73-22-3 | L-Tryptophan | 4B |
| 9011-05-6 | Urea-formaldehyde resin | 4B |
| 28430-58-2 | Vinyl acetate, polymer with methyl acrylate and methyl | 4B |
| | methacrylate | |
| 25067-01-0 | Vinyl acetate, polymer with n-butyl acrylate | 4B |
| 25085-41-0 | Vinyl acetate-butyl acrylate-acrylic acid terpolymer | 4B |
| 25213-24-5 | Vinyl alcohol-vinyl acetate copolymer | 4B |
| 9003-22-9 | Vinyl chloride-vinyl acetate copolymer | 4B |
| 25086-48-0 | Vinyl chloride, vinyl acetate and vinyl alcohol copolymer | 4B |
| 28062-44-4 | Vinyl pyrrolidone-acrylic acid copolymer | 4B |
| 30581-59-0 | Vinyl pyrrolidone-dimethylaminoethylmethacrylate | 4B |
| | copolymer | |
| 25086-29-7 | Vinylpyrrolidinone-styrene polymer | 4B |
| 68-26-8 | Vitamin A | 4B |
| 12001-76-2 | Vitamin B complex | 4B |
| 68-19-9 | Vitamin B12 | 4B |
| 67-97-0 | Vitamin D3 | 4B |
| | Wheat (raw and processed forms) | LISTNO |
| 130498-22-5 | Wheat flour | 4B |
| 68608-58-2 | Whey | 4B |
| | Wood flour | 4B |
| 58-86-6 | D-Xylose | 4B |
| 7440-66-6 | Zinc (metallic) | 4B |
| 7779-88-6 | Zinc nitrate | 4B |

1. A pesticide composition consisting essentially of:
about 2 to 4% cedar oil;
about 0.5 to 1% cinnamon oil;
a carrier consisting essentially of water; and
polysorbate provided in an amount sufficient for substantially solubilizing said cedar and cinnamon oils in said carrier, wherein said cedar and cinnamon oils are the only essential oils present in the formulation.

2. (canceled)

3. A natural pesticide composition consisting essentially of:
cedar and cinnamon oils, present in a ratio of approximately 2:1, as the only effective insect repelling ingredients;
an inert carrier, consisting essentially of water; and
polysorbate present in an amount sufficient to solubilize said cedar and cinnamon oils.

4. (canceled)

5. A pesticide method using essential oils as the only pesticide active ingredients, the method comprising:
providing a composition consisting essentially of:
an effective amount of pesticide active ingredients consisting essentially of cedar oil and cinnamon oil;
optionally, a carrier said carrier consisting essentially of water; and
optionally, a surfactant in an amount sufficient to homogenize said active ingredients in said carrier, said surfactant consisting essentially of polysorbate; and
applying said composition to an area from which a user desires to repel said pests.

6. The method of claim 5, wherein said pests include insects, rodents, reptiles, or a combination thereof.

7. The method of claim 5, said composition including water.

8. The method of claim 5 said composition further including polysorbate.

9. The method of claim 5, said step of applying comprising:
providing a spray container containing said composition; and
spraying said composition onto said area.

10. The method of claim 5 wherein the cinnamon oil and cedar oil are present in an amount of up to 8.5% by volume.

11. The method of claim 5, said composition containing amounts of cedar and cinnamon oils which are essentially non-toxic to humans.

12. The method of claim 5 wherein said repellant is non-irritating to human skin.

13. A natural pesticide composition comprising:
an effective amount of essential oils consisting essentially of cedar and cinnamon oils, as the only essential oils and only fragrance sources;
a carrier, comprising water, and
wherein said composition has a distinct cedar and cinnamon fragrance.

14. The composition of claim 13, further comprising polysorbate, in an amount sufficient to substantially dissolve said essential oils in said carrier.

15. The composition of claim 1 wherein said composition has a distinct cedar and cinnamon fragrance.
